(19) United States
(12) Patent Application Publication
(10) Pub. No.: US 2007/0266187 A1
(43) Pub. Date: Nov. 15, 2007

(54) Data Interleaving Apparatus

(76) Inventor: Daigo Senoo, Osaka (JP)

Correspondence Address: MCDERMOTT WILL & EMERY LLP, 600 13TH STREET, NW, WASHINGTON, DC, 20005-3096, US

(21) Appl. No.: 11/663,969

(22) PCT Filed: Sep. 5, 2005
(86) PCT No.: PCT/JP05/16221

§ 371 Date: Mar. 28, 2007

(30) Foreign Application Priority Data
Sep. 29, 2004 (JP) 2004-284857

(51) Int. Cl. G06F 13/28

(52) U.S. Cl. 710/26

(57) ABSTRACT

In a data interleaving apparatus, a SRAM sorting circuit 800 judges which the first half (SRAMs 700 and 710) or the latter half (SRAMs 720 and 730) of memory region SRAMs 700 through 730 address information for deinterleaving data transmitted by a DMA apparatus 100 corresponds to, and perform allocation. The DMA apparatus 100 transmits two addresses each time and data corresponding to one of the two addresses is written in a first memory region (SRAM 700 or 720) divided in a different manner from the above, and at the same time, data corresponding to the other one of the addresses is written in a second memory region (SRAM 710 or 730). In a DMA apparatus 200 for transmitting an address for taking out interleave data, a SRAM sorting circuit 810 performs, in the same manner, simultaneous processing to the first half and latter half regions in the memory SRAMs and simultaneous processing to the first and second memory regions. Accordingly, operation speed can be improved without increasing a frequency.

The present invention relates to data interleaving apparatus for performing, in a larger volume optical disk represented by Blu-ray Disc, deinterleaving when large volume data such as AV data, computer data and the like is transferred or reproduced.

### BACKGROUND ART

Conventionally, in a recording medium such as a DVD and the like, an error correcting code such as a Reed-Solomon code and the like has been used to correct an error due to a defect of the medium, and dusts and scratches on a disk surface. In more recent years, further research of next generation digital video recording for the purpose of increasing the degree of density and recording capacity of recording medium, compared to known DVDs. In such research, as the degree of density of recording medium has been increased, reduction in the influence of burst errors due to dusts and scratches has been desired.

In response to above-described needs, for example, as an error correction method for improving the correction ability with respect to burst error, a method for interleaving two different types of error correction codes and recording them has been proposed in Patent Reference 1. Based on the interleaving method, Blu-ray Disc has been developed.

A known apparatus for performing interleaving/deinterleaving when data is transferred is shown in FIG. 1.

In this example, deinterleaving of Blu-ray Disc is described.

A DMA apparatus 1100 includes an interleave address computing unit for computing an address for deinterleaving. The reference numeral 1700 denotes an SRAM for temporarily holding data when deinterleaving of interleave data 1001 is performed. The DMA apparatus 1100 outputs a write request 1102 for requesting data writing into the SRAM 1700 and a write address 1103 of data to be written in the SRAM 1700 and performs handshake for receiving a write acknowledge 1101 indicating write completion. In Blu-ray Disc, interleaving occurs for each Byte. Accordingly, the DMA apparatus 1100 issues address information once for every Byte.

A DMA apparatus 1200 includes an address computing unit for computing an address for obtaining deinterleaved data. The DMA apparatus 1200 outputs a read request 1202 for requesting data read of recorded data from the reference numeral 1700 and a read address 1203 in the reference numeral 1700 and performs handshake for receiving a read acknowledge 1201 indicating read completion. In the DMA apparatus 1200 of this example, an address is issued once for every 4 Byte.

A FIFO apparatus 1300 receives the interleave data 1001 and outputs FIFO data 1301 according to a request from the DMA apparatus 1100.

A FIFO apparatus 1400 receives FIFO data 1401 obtained by the read request 1202 of the DMA apparatus 1200 and outputs deinterleave data 1002.

An arbitration circuit 1500 receives the write request 1102 from the DMA apparatus 1100 and the read request 1202 from the DMA apparatus 1200 and selects a higher priority request out of the two requests. In this example, the write request 1102 of the DMA apparatus 1100 has a higher priority than the read request 1202 of the DMA apparatus 1200.

In a write operation, when an SRAM interface (which will be hereafter abbreviated as I/F) 1600 receives a request 1501, address information 1502, a write enable 1503 and write data 1504 from the arbitration circuit 1500, the I/F 1600 outputs a chip select 1601, a byte enable 1602, write enable 1603, an address 1604 and write data 1605 according to an SRAM protocol (specification). In a read operation, the I/F 1600 outputs the chip select 1601, the byte enable 1602, the write enable 1603 and the address 1604, receives read data 1606 and outputs read data 1506 and a completion notice 1505 to the arbitration circuit 1500.

Next, a time series operation of the data interleaving apparatus of FIG. 1 will be described with reference to FIG. 2. As shown in FIG. 2(A), the DMA apparatus 1100 performs a deinterleaving operation from a time T01 to a time T02. When a deinterleaving unit by the DMA apparatus 1100 is completed, the DMA apparatus 1200 performs an operation of taking out, as deinterleaved data, data recorded from the time T01 to the time T02. Next, the DMA apparatus 1100 performs deinterleaving to next data from a time T03 to a time T04. Again, when a deinterleaving unit by the DMA apparatus 1100 is completed, the DMA apparatus 1200 performs an operation of taking out deinterleaved data from the time T04 to a time T05. By repeating the above-described operation, deinterleaving can be performed.

In actual data transfer for Blu-ray Disc or the like, the interleave data 1001 is transmitted at every moment in many cases and thus a stop state of the DMA apparatus 1100 as in a period from the time T02 to the time T03 is not be permitted some times. In such a case, a capacity of a memory device is prepared to correspond to twice as large as a deinterleave amount and a two- or more-part structure is formed of a plurality of memory devices. Thus, the data transfer can be pipelined. A time series operation to be performed when a two-part structure is shown in FIG. 2(B).

First, the DMA apparatus 1100 performs deinterleaving from a time T11 to a time T12. When the deinterleaving unit is completed, the DMA apparatus 1200 performs an operation of taking out deinterleaved data from the time T12. In this operation, using another part, the DMA apparatus 1100 performs deinterleaving from the time T12 to a time T13. By repeating the above-described operation, deinterleaving can be performed at high speed.

As described above, in recent years, multi-fold increase in operation speed is required in the optical disk field. Assumed that a circuit frequency is x (MHz). Under the condition where the DMA apparatus 1100 is 1 Byte access, the DMA apparatus 1200 is 4 Byte access and a total of a transfer amount 0 is the same for both the DMA apparatuses 1100 and 120, a maximum transfer speed of this circuit is 0.8x (MBps). Therefore, to improve a property of increasing speed, the circuit frequency x has to be increased.
Patent Reference 1: Japanese National Publication of Translated Version No. 2002-521789

### DISCLOSURE OF THE INVENTION

Problems That the Invention is to Solve

However, if a frequency of a circuit is increased, it becomes difficult to constrain timing. Accordingly, several problems arise. For example, in order to ensure timing constraint, a circuit size is increased, thus resulting in increase in power consumption. In a semiconductor device or the like, a heat radiator plane is needed or the like, thus resulting in increase in costs. Also, a circuit with an increased frequency can not be used for a slim drive for notebook.

In a normal DMA apparatus, transfer ability can be improved by increasing a band width, e.g., from 1 Byte to 4 Bytes. However, in this example, as a precondition, interleaving occurs for each Byte and thus an address of discontinuous data can not be extracted. Therefore, 2 or more Byte access is not possible.

The present invention has been devised to solve the above-described known problems and it is therefore an object of the present invention to suppress increase in a circuit frequency to a minimum level and allow increase in operation speed.

Solution to the Problems

To achieve the above-described object, according to the present invention, with a focus on the fact that in interleave data of which continuous addresses are to be successively transmitted, a certain bit of each of the addresses of the interleave data has periodicity, operation speed is increased by specifying, based on the periodicity, 2 Byte interleave data while setting two memory regions in a memory device and performing processing to the 2 Byte interleave data.

Moreover, addresses of interleave data to be received are divided into two regions and two memory regions corresponding to the two divided addresses, respectively, are set in a memory device from a different view point from the two memory regions. Then, while interleave data corresponding to one of the two divided addresses is processed, processing is performed to interleave data corresponding to the other of the two divided addresses, thereby further increasing operation speed.

Specifically, a data interleaving apparatus according to the present invention is directed to data interleaving apparatus for receiving multiple interleave data that have been interleaved and outputting multiple deinterleave data that have been deinterleaved, and includes: a memory device having two memory regions consisting of a first memory region and a second memory region; a first DMA apparatus for simultaneously transmitting two addresses obtained from respective addresses of the multiple interleave data which have been continuously received, based on a predetermined rule, and transmitting a write request for simultaneously writing one of the two interleave data corresponding to the two addresses into the first memory region of the memory device and the other one of the two interleave data into the second memory region of the memory device; and a memory device interface for controlling a write operation of simultaneously writing respective two write data corresponding to the two addresses in the first and second memory regions of the memory device, respectively, based on the write request and the two addresses which have been transmitted by the first DMA apparatus.

The present invention is characterized in that the data interleaving apparatus further includes: a second DMA apparatus for transmitting two addresses as two read data for simultaneously reading, from the first and second memory regions of the memory device, said one interleave data stored and written in the first and second memory regions of the memory device and a read request for reading the two read data; and a memory device interface for controlling a read operation of simultaneously reading the two read data corresponding to the two addresses from the first and second memory regions of the memory device, respectively, based on the read request and the two addresses of the two read data which have been transmitted by the second DMA apparatus.

The present invention is characterized in that the data interleaving apparatus further includes: a first request allocation circuit for associating parts of each of the first and second memory regions of the memory device to first and latter half regions of an address of each of the two write data and allocating each of the two write data to one of the first and latter half regions of an associated one of the first and second memory regions, based on the write request and the two addresses of the two write data which have been transmitted by the first DMA apparatus; a second DMA apparatus for transmitting the two addresses for reading data stored in the memory device as well as a read request; and a second request allocation circuit for associating parts of each of the first and second memory regions of the memory device to first and second half regions of an address of each of the two write data and allocating each of the two read data to one of the first and latter half regions of an associated one of the first and second memory regions, based on the read request and the two addresses of the two read data transmitted by the second DMA apparatus.

The present invention is characterized in that the predetermined rule is a rule according to an interleave rule for Blu-ray Disc that as respective least significant bits of the respective addresses of the multiple interleave data, even numbers and odd numbers are alternatively arranged, and respective least significant bits of the two addresses are an even number and an odd number out of the even numbers and odd numbers alternatively arranged, the even number and the odd number being continuous numbers.

The present invention is characterized in that the data interleaving apparatus further includes: a second DMA apparatus for transmitting the two addresses as two read data for reading, from the memory device, said one interleave data stored and written in the memory device and a read request for reading the two read data; and an arbiter apparatus for receiving the write request transmitted by the first DMA apparatus and the read request transmitted by the second DMA apparatus and performing arbitration for determining an order of priorities of the write request and read request, and an operation frequency of the memory device interface is n fold (n is an integer of 2 or larger) or more of an operation frequency of the arbiter apparatus.

The present invention is characterized in that the data interleaving apparatus further includes: a first DMA apparatus for transmitting the two addresses of two write data of said one interleave data stored and written in the memory device and a write request for a write operation of writing the two write data; and an arbiter apparatus for receiving the write request transmitted by the first DMA apparatus and the read request transmitted by the second DMA apparatus and performing arbitration for determining an order of priorities of the write request and the read request, and an operation frequency of the memory device interface is n fold (n is an integer of 2 or larger) or more of an operation frequency of the arbiter apparatus.

The present invention is characterized in that the data interleaving apparatus further includes an arbiter apparatus for receiving the write request transmitted by the first DMA apparatus and the read request transmitted by the second DMA apparatus and performing arbitration for determining an order of priorities of the write request and the read request, and an operation frequency of the memory device interface is n fold (n is an integer of 2 or larger) or more of an operation frequency of the arbiter apparatus.

The present invention is characterized in that the arbiter apparatus performs processing to respective transfer requests for the two write data with respect to the two addresses transmitted from the first DMA apparatus at the same timing.

The present invention is characterized in that the arbiter apparatus performs processing to respective transfer requests for the two write data with respect to the two addresses transmitted from the second DMA apparatus at the same timing.

The present invention is characterized in that the memory device is a DRAM or an SRAM.

As has been described, according to the present invention, the DMA apparatus for specifying write data address can specify two addresses for each of multiple addresses of multiple interleave data to be received, based on a predetermined rule and two memory regions are set in a memory device. Thus, two sets of interleaving operations can be simultaneously performed to the two memory regions.

Specifically, according to the present invention, each of multiple addresses to be processed is divided into a first half and a second half and two memory regions are set in a memory device according to the address division. Thus, a write operation to one of the two memory regions and a read operation to the other of the two memory regions can be simultaneously performed.

Effects of the Invention

As has been described, with the data interleaving apparatus of the present invention, the DMA apparatus for transmitting an address of write data can transmit two addresses at a time. Thus, operation speed can be increased without increasing an operation clock.

Specifically, according to the present invention, addresses of data to be processes are divided into a first half address and a latter half address and stored in two different memory regions. Thus, a write operation and a read operation can be independently performed to the two memory devices at the same time. Accordingly, operation speed can be increased without increasing an operation clock.

### BRIEF DESCRIPTION OF THE DRAWINGS

FIG. 1 is a block diagram of a known data interleaving apparatus.

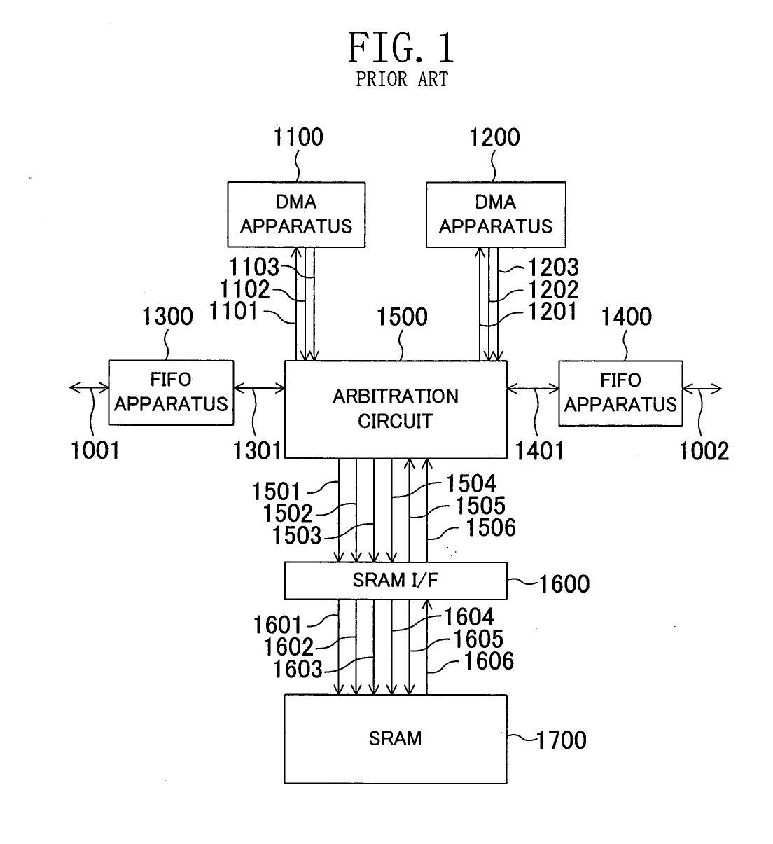

FIG. 2(A) is a diagram illustrating an operation of the known data interleaving apparatus including a single-part memory region; and FIG. 2(B) a diagram illustrating an operation of the known data interleaving apparatus including a two-part memory region.

FIG. 3 is a block diagram of a data interleaving apparatus according to an embodiment of the present invention.

### EXPLANATION OF REFERENCE NUMERALS

100 DMA apparatus (first DMA apparatus)
200 DMA apparatus (second DMA apparatus)
500 Arbitration circuit (arbiter apparatus)
520 Arbitration circuit (arbiter apparatus)
600 SRAMI/F (Memory device interface)
620 SRAMI/F (Memory device interface)
700 SRAM (first memory region, first half region)
710 SRAM (second memory region, first half region)
720 SRAM (first memory region, latter half region)
730 SRAM (second memory region, latter half region)

### BEST MODE FOR CARRYING OUT THE INVENTION

Hereafter, a data interleaving apparatus according to this embodiment will be described with reference to the accompanying drawings.

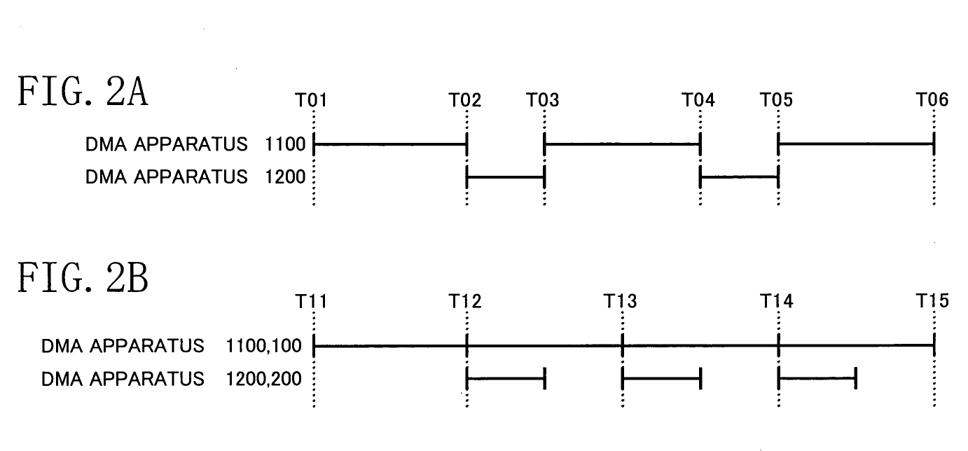

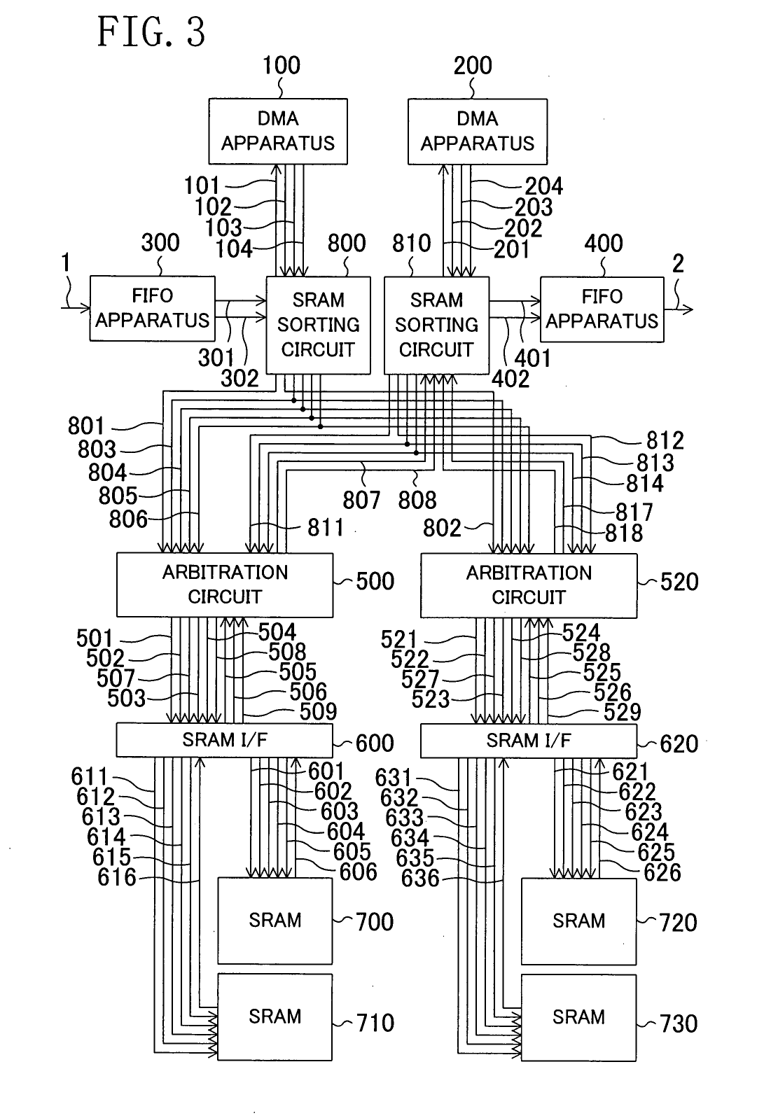

An embodiment of a data interleaving apparatus for performing deinterleaving according to the present invention is shown in FIG. 3. In this embodiment, deinterleaving in pipeline processing shown in FIG. 2(B) is used as an example. In this embodiment, description will be made using interleave data in Blu-ray Disc as an example.

The data interleaving apparatus of FIG. 3 receives interleave data 1 via a FIFO apparatus 300, stores data after deinterleaving of the interleave data 1, reads the data after deinterleaving from a SRAM and outputs the data as deinterleave data 2 via a FIFO apparatus 400.

In this embodiment, as the SRAM, a SRAM 700, a SRAM 710, a SRAM 720 and a SRAM 730 obtained by dividing the RAM 1700 of FIG. 7 as a known memory device into four are used. Accordingly, each of the four SRAMs has a capacity corresponding to ¼ of a capacity of the SRAM. Assume that the known SRAM 1700 has 4 KBytes and the same amount of capacity as this is divided into 4. Therefore, a capacity of each of the SRAM 700, the SRAM 710, the SRAM 720 and the SRAM 730 is 1 KByte. In this case, 4 KBytes corresponding to the capacity of the known SRAM is divided into first half addresses (000-7FF) and latter half addresses (800-FFF). A first half region of the SRAM corresponding to the first half address group of the two divided address groups is allocated to a region including the SRAM 700 and the SRAM 710 and a latter half region of the SRAM corresponding to the latter half address group is allocated to a region including the SRAM 720 and the SRAM 730.

The reference numeral 100 denotes a DMA apparatus (first DMA apparatus) including an interleave address computing unit (not shown) for computing an address for deinterleaving the interleave data 1 to be received. The DMA apparatus 100 computes two addresses 103 and 104 for deinterleaving. According to the interleave rule used for Blu-ray Disc, as respective least significant bits of continuous interleave data, even numbers and odd numbers are alternately arranged (according to a predetermined rule). The interleave address computing unit of the DMA apparatus 100 of this embodiment performs computing with continuous two even and odd number addresses as a group, i.e., for every 2 Byte.

The reference numeral 800 denotes a SRAM sorting circuit. The SRAM sorting circuit 800 receives a request (write request) for requesting a write operation of writing the addresses 103 and 104 computed by the DMA apparatus 100 and data corresponding to the two addresses and, when a write operation has been completed, transmits an acknowledge 101 indicating write completion to the DMA apparatus 100. The SRAM sorting circuit 800 performs this handshake with the DMA apparatus 100.

The SRAM sorting circuit (first request allocation circuit) 800 receives FIFO data 301 and FIFO data 302 corresponding to the address 103 and the address 104 output from the DMA apparatus 100, respectively, and sorts addresses 803 and 804 output depending on which the addresses 103 and 104 are the addresses of the first half region or the addresses of the latter half region of the SRAM and write data 805 and write data 806 corresponding to the address 803 and the address 804, respectively. That is, the SRAM sorting circuit 800 performs allocation for a write request 102.

The reference numeral 200 denotes a DMA apparatus (second DMA apparatus). In the same manner as the DMA apparatus 100, the DMA apparatus 200 computes two addresses 203 and 204 of data to be output as the deinterleave data 2 from data which has been deinterleaved and stored in the SRAM by an address computing unit (not shown) provided in the DMA apparatus 200.

The reference numeral 810 denotes an SRAM sorting circuit. The SRAM sorting circuit 810 receives, from the DMA apparatus 200, the addresses 203 and 204 computed by the DMA apparatus 200 and a request (read request) for requesting a read operation of reading data corresponding to the two addresses from the SRAM and, when a read operation has been completed, transmits an acknowledge 201 indicating read completion to the DMA apparatus 200. The SRAM sorting circuit 810 performs this handshake with the DMA apparatus 200.

The SRAM sorting circuit (second request allocation circuit) 810 outputs FIFO data 401 and FIFO data 402 corresponding to the address 203 and the address 204 output from the DMA apparatus 200, respectively, from the FIFO apparatus 400 and sorts destinations for addresses 803 and 804 output depending on which the addresses 203 and 204 are the addresses of the first half region or the addresses of the latter half region of the SRAM and read data 817 and write data 818 corresponding to the address 803 and the address 804, respectively. That is, the SRAM sorting circuit 800 performs allocation for a read request 202.

The reference numeral 500 denotes an arbitration circuit (arbiter apparatus) for performing arbitration of input/out of data with respect to the SRAM 700 and the SRAM 710 (one of two divided memory regions or the first half region) of the four regions of the SRAM. The reference numeral 510 denotes an arbitration circuit (arbiter apparatus) for performing arbitration of input/output of data with respect to the SRAM 720 and the SRAM 730 (the other of two divided memory regions or the latter half region) of the four regions of the SRAM. When the addresses 103 and 104 output from the DMA apparatus 100 are the addresses of the first half region of the SRAM, the SRAM sorting circuit 800 outputs a request 801 and performs sorting to the arbitration circuit 500. When the addresses 103 and 104 are the addresses of the latter half region of the SRAM, the SRAM sorting circuit 800 outputs a request 802 and performs sorting to the arbitration circuit 520. Moreover, When the addresses 203 and 204 output from the DMA apparatus 200 are the addresses of the first half region of the SRAM, the SRAM sorting circuit 810 outputs a request 811 and performs sorting to the arbitration circuit 500. When the addresses 203 and 204 are the addresses of the latter half region of the SRAM, the SRAM sorting circuit 810 outputs a request 812 and performs sorting to the arbitration circuit 520.

The reference numeral 600 denotes an SRAMI/F. The SRAMI/F 600 performs a write operation or a read operation to the SRAM 700 and the SRAM 710 at the same time, based on a request 501, addresses 502 and 507, a write enable 503 and data 504 and data 508 corresponding to the address 502 and the address 507, respectively, which all have been output as a result of arbitration of the arbitration circuit 500. The reference numeral 620 denotes an SRAMI/F. The SRAMI/F 620 performs a write operation or a read operation to the SRAM 720 and the SRAM 730 at the same time, based on a request 521, addresses 522 and 527, a write enable 523 and data 524 and data 528 corresponding to the address 522 and the address 527, respectively, which all have been output as a result of arbitration of the arbitration circuit 520.

Hereafter, the operation of the data interleaving apparatus of FIG. 3 will be described.

The FIFO apparatus 300 for receiving interleave data 001 in which interleaving occurs for each Byte and holding the interleave data 1 in an flipflop provided therein outputs 1 Byte FIFO data 301 and 1 Byte FIFO data 302 indicating a data value following that of the FIFO data 301.

The DMA apparatus 100 outputs a request 102 for requesting a write operation to a SRAM, an address 103 for the SRAM and an address 104 for data following the address 103 to the SRAM sorting circuit 800 and receives an acknowledge 101 indicating transfer completion from the SRAM sorting circuit 800. In this case, the address 103 corresponds to the FIFO data 301 and the address 104 corresponds to FIFO data 302.

If the address 103 and the address 104 indicates the first half addresses (000-7FF) of the 4 Byte SRAM, the SRAM sorting circuit 800 which has received the FIFO data 301, the FIFO data 302, the request 102, the address 103 and the address 104 asserts a request 801 and outputs to the arbitration circuit 500 an address 803, i.e., an 11 bit address obtained by excluding the highest order 1 bit from the address 103, an address 804, i.e., an 11 bit address obtained by excluding the highest order 1 bit from the address 104, the FIFO data 301 as a 1 Byte write data 805 corresponding to the address 803 and the FIFO data 302 as a 1 Byte write data 806 corresponding to the address 804.

If the address 103 and the address 104 indicates the latter half addresses (800-FFF) of the 4 KByte SRAM, the SRAM sorting circuit 800 asserts a request 802 and outputs to the arbitration circuit 520 an address 803, i.e., an 11 bit address obtained by excluding high 1 bit from the address 103, an address 804, i.e., an 11 bit address obtained by excluding high bit from the address 104, the FIFO data 301 as a 1 Byte write data 805 corresponding to the address 803 and the FIFO data 302 as a 1 Byte write data 806 corresponding to the address 804.

Since both of the address 103 and the address 104 which are continuous addresses in pipeline processing indicate, at the same time, the first half addresses or the latter half addresses, the DMA apparatus 100 does not assert both of the request 801 and the request 802 at the same time.

Next, the case where the address 103 and the address 104 indicate the first half addresses will be described.

The arbitration circuit 500 receives the request 801, the address 803, the address 804, the write data 805 and the write data 806 and performs arbitration with request information from the DMA apparatus 200. However, this embodiment is characterized in that even in the pipeline processing (B) of FIG. 2, each of addresses of the DMA apparatus 100 and the DMA apparatus 200 is exclusive with respect to the first half addresses and the latter half addresses of the 4 KByte SRAM. Accordingly, there is no wait time for processing the request 801. Then, the address 502, 1 Byte write data 504 corresponding to the address 502, the address 507 and 1 Byte write data 508 corresponding to the address 507 are output at the same timing to assert the request 501 and the write enable 503.

The SRAMI/F (memory device interface) 600 judges the received addresses 502 and 507. If each of the addresses 502 and 507 indicates an even number address, the SRAMI/F 600 issues to the SRAM 700 an address 604, a byte enable 602 and a write data 605 and asserts a chip select 601 and a write enable 602. If each of the addresses 502 and 507 indicates an odd number address, the SRAMI/F 600 issues to the SRAM 710 an address 614, a byte enable 612 and a write data 615 and asserts a chip select 611 and a write enable 612. According to the interleave rule, in deinterleaving of Blu-ray Disc in which continuous addresses all are even numbers or odd numbers and each of the addresses is exclusive at any time, the addresses 502 and 507 (two addresses) exclusively select the SRAM 700 (first memory region) and the SRAM 710 (second memory region), respectively, and accesses to both the SRAM 700 and the SRAM 710 are completed at the same time within a cycle. In this case, an operational frequency of the SRAMI/F 600 is n (n is an integer of 2 or more) times as high as an operational frequency of the arbitration circuit 500.

In the same manner, the case where the address 103 and the address 104 indicate the latter half addresses will be described.

The arbitration circuit 520 receives the request 802, the address 803, the address 804, the write data 805 and the write data 806 and performs arbitration with request information from the DMA apparatus 200. As in the case of the first half address, there is no wait time for processing the request 802 and the arbitration circuit 520 outputs the address 522, 1 Byte write data 524 corresponding to the address 522, the address 527 and 1 Byte write data 528 corresponding to the address 527 are output at the same timing and asserts the request 521 and the write enable 523.

The SRAMI/F (memory device interface) 620 judges the received addresses 522 and 527. If each of the addresses 522 and 527 indicates an even number address, the SRAMI/F 620 issues to the SRAM 720 an address 624, a byte enable 622 and a write data 625 and asserts a chip select 621 and a write enable 622. If each of the addresses 522 and 527 indicates an odd number address, the SRAMI/F 620 issues to the SRAM 730 an address 634, a byte enable 632 and a write data 635 and asserts a chip select 631 and a write enable 632. In the same manner as described above, these accesses are completed at the same time within a cycle.

The above-described operation, the operation of the DMA apparatus 100 is not affected by the DMA apparatus 200 and thus a deinterleaving operation can be performed at a two-fold speed of that of the known example. As in the known example, assume that a circuit frequency is x (MHz). Under the condition where processing of 2 Bytes within 1 cycle is possible and the operation is not affected by the DMA apparatus 200, a maximum transfer rate is simply 2x (Mbps). Therefore, two- or more-fold higher performance can be achieved.

In this embodiment, the speed of an operation of the DMA apparatus 200 for taking out deinterleave data is also increased.

The FIFO apparatus 400 receives 4 Byte FIFO data 401 which is deinterleaved data and FIFO data 402 following the FIFO data 401 at the same time, stores the FIFO data 401 and the FIFO data 402 in a flipflop and outputs 4 Byte deinterleave data 002 which is deinterleaved data.

The DMA apparatus 200 outputs a request 202 for requesting a read operation to a SRAM, an address 203 for the SRAM and an address 204 for following data and receives an acknowledge 201 indicating transfer completion. In this case, the address 203 corresponds to the FIFO data 401 and the address 204 corresponds to the FIFO data 402.

If each of the addresses 203 and 204 indicates a first half address (000-7FF) of the 4 KByte SRAM, the SRAM sorting circuit 800 which has received the request 202, the address 203 and the address 204 asserts a request 811, outputs to the arbitration circuit 500 an address 813 i.e., an 11 bit address obtained by excluding the highest 1 bit from the address 203, an address 814, i.e., an 11 bit address obtained by excluding the highest 1 bit from the address 204 and obtains read data 807 as the FIFO data 401 and read data 808 as the FIFO data 402.

If each of the addresses 203 and 204 indicates a first half address (800-FFF) of the 4 KByte SRAM, the SRAM sorting circuit 800 asserts a request 812, outputs to the arbitration circuit 520 an address 813 i.e., an 11 bit address obtained by excluding the highest 1 bit from the address 203, an address 814, i.e., an 11 bit address obtained by excluding the highest 1 bit from the address 204 and obtains read data 817 as the FIFO data 401 and read data 818 as the FIFO data 402.

In the same manner as in the DMA apparatus 100, since each of the addresses 203 and 204 which are continuous in pipeline processing exclusively indicates the first half address or the latter half address of the 4 KByte SRAM, the request 811 and the request 812 are not asserted at the same time.

Next, the case where the address 103 and the address 104 indicate the first half addresses will be described.

The adjustment circuit 500 receives the request 801, the address 803 and the address 804 and performs arbitration with request information from the DMA apparatus 200. However, this embodiment is characterized in that, as shown in simultaneous processing in the pipeline processing (B) of FIG. 2, each of addresses of the DMA apparatus 100 and the DMA apparatus 200 is exclusive with respect to the first half addresses and the latter half addresses of the 4 KByte SRAM. Accordingly, there is no wait time for processing the request 801 of the DMA apparatus 100 and the arbitration circuit 500 outputs the address 502 and the address 507 to the SRAMI/F 600 and also outputs 1 Byte write data 504 corresponding to the address 502 and 1 Byte write data 508 corresponding to the address 507. The adjustment circuit 500 asserts the request 501 and the write enable 503.

The SRAMI/F 600 judges the received addresses 502 and 507. If each of the addresses 502 and 507 indicates an even number address, the SRAMI/F 600 issues to the SRAM 700 an address 604, a byte enable 602 and a write data 605 and asserts a chip select 601 and a write enable 602. If each of the addresses 502 and 507 indicates an odd number address, the SRAMI/F 600 issues to the SRAM 710 an address 614, a byte enable 612 and a write data 615 and asserts a chip select 611 and a write enable 612. According to the interleave rule, in deinterleaving of Blu-ray Disc in which one of arbitrary continuous addresses is an even number and the other is an odd number and the addresses are in an exclusive relationship at any time, the addresses 502 and 507 exclusively select the SRAM 700 and the SRAM 710, respectively, and accesses to both the SRAM 700 and the SRAM 710 are completed at the same time within a cycle.

In the same manner, the case where the address 103 and the address 104 indicate the latter half addresses will be described.

The arbitration circuit 520 receives the request 802, the address 803 and the address 804 and performs arbitration with request information from the DMA apparatus 200. Also, in this case, as in the case of the first half address, because of the characteristic that each of the addresses of the DMA apparatus 100 and the DMA apparatus 200 is exclusive with respect to the first half addresses and the latter half addresses of the 4 KByte SRAM, there is no wait time for processing the request 802 and the arbitration circuit 520 outputs the address 522 and 1 Byte write data 524 corresponding to the address 522 and also outputs the address 527 and 1 Byte write data 528 corresponding to the address 527 to the SRAMI/F 620. The arbitration circuit 520 asserts the request 521 and the write enable 523.

The SRAMI/F 620 judges the received addresses 522 and 527. If each of the addresses 522 and 527 indicates an even number address, the SRAMI/F 620 issues to the SRAM 720 an address 624, a byte enable 622 and a write data 625 and asserts a chip select 621 and a write enable 622. If each of the addresses 522 and 527 indicates an odd number address, the SRAMI/F 620 issues to the SRAM 730 an address 634, a byte enable 632 and a write data 635 and asserts a chip select 631 and a write enable 632. In the same manner as the above-described manner, these accesses are completed within a cycle.

As described above, the operation of the DMA apparatus 100 is exclusively performed so as to be separated from the operation of the DMA apparatus 200 for taking out deinterleaved data stored in the SRAM. Thus, a high speed operation can be achieved.

In this embodiment, the example where an SRAM is used as a memory device for storing data obtained after deinterleaving. However, instead of the SRAM, a DRAM may be used.

### INDUSTRIAL APPLICABILITY

As has been described, a data interleaving apparatus according to the present invention has the effect of improving a processing speed without increase in an operation clock and therefore is useful for deinterleaving when large volume data is transferred or reproduced in a large volume optical disk represented by Blu-ray Disc and the like.

1. A data interleaving apparatus for receiving multiple interleave data that have been interleaved and outputting multiple deinterleave data that have been deinterleaved, the apparatus comprising:
a memory device having two memory regions consisting of a first memory region and a second memory region;
a first DMA apparatus for simultaneously transmitting two addresses obtained from respective addresses of the multiple interleave data which have been continuously received, based on a predetermined rule, and transmitting a write request for simultaneously writing one of parts of one of the multiple interleave data corresponding to the two addresses into the first memory region of the memory device and the other one of the two interleave data into the second memory region of the memory device; and
a memory device interface for controlling a write operation of simultaneously writing respective two write data corresponding to the two addresses in the first and second memory regions of the memory device, respectively, based on the write request and the two addresses which have been transmitted by the first DMA apparatus;
a first request allocation circuit for dividing each of the first and second memory regions of the memory device into first and latter half regions for an address of each of the two write data and allocating each of the two write data to one of the first and latter half regions of an associated one of the first and second memory regions based on the write request and the two addresses of the two write data which have been transmitted by the first DMA apparatus;
a second DMA apparatus for transmitting the two addresses for reading data stored in the memory device as well as a read request; and
a second request allocation circuit for dividing each of the first and second memory regions of the memory device into first and second half regions for an address of each of the two write data and allocating each of the two read data to one of the first and latter half regions of an associated one of the first and second memory regions, based on the read request and the two addresses of the two read data transmitted by the second DMA apparatus.

2. The data interleaving apparatus of claim 1, further comprising:
a second DMA apparatus for transmitting two addresses as two read data for simultaneously reading, from the first and second memory regions of the memory device, said one interleave data stored and written in the first and second memory regions of the memory device and a read request for reading the two read data; and
a memory device interface for controlling a read operation of simultaneously reading the two read data corresponding to the two addresses from the first and second memory regions of the memory device, respectively, based on the read request and the two addresses of the two read data which have been transmitted by the second DMA apparatus.

3. (canceled)

4. The data interleaving apparatus of claim 1, wherein the predetermined rule is a rule according to an interleave rule for Blu-ray Disc that as respective least significant bits of the respective addresses of the multiple interleave data, even numbers and odd numbers are alternatively arranged, and
respective least significant bits of the two addresses are an even number and an odd number out of the even numbers and odd numbers alternatively arranged, the even number and the odd number being continuous numbers.

5. The data interleaving apparatus of claim 1, further comprising:
a second DMA apparatus for transmitting the two addresses as two read data for reading, from the memory device, said one interleave data stored and written in the memory device and a read request for reading the two read data; and
an arbiter apparatus for receiving the write request transmitted by the first DMA apparatus and the read request transmitted by the second DMA apparatus and performing arbitration for determining an order of priorities of the write request and read request,
wherein an operation frequency of the memory device interface is n fold (n is an integer of 2 or larger) or more of an operation frequency of the arbiter apparatus.

6. The data interleaving apparatus of claim 2, further comprising:
a first DMA apparatus for transmitting the two addresses of two write data of said one interleave data stored and written in the memory device and a write request for a write operation of writing the two write data; and
an arbiter apparatus for receiving the write request transmitted by the first DMA apparatus and the read request transmitted by the second DMA apparatus and performing arbitration for determining an order of priorities of the write request and the read request,
wherein an operation frequency of the memory device interface is n fold (n is an integer of 2 or larger) or more of an operation frequency of the arbiter apparatus.

7. The data interleaving apparatus of claim 1, further comprising an arbiter apparatus for receiving the write request transmitted by the first DMA apparatus and the read request transmitted by the second DMA apparatus and performing arbitration for determining an order of priorities of the write request and the read request,
wherein an operation frequency of the memory device interface is n fold (n is an integer of 2 or larger) or more of an operation frequency of the arbiter apparatus.

8. The data interleaving apparatus of claim 5, wherein the arbiter apparatus performs processing to respective transfer requests for the two write data with respect to the two addresses transmitted from the first DMA apparatus at the same timing.

9. The data interleaving apparatus of claim 6, wherein the arbiter apparatus performs processing to respective transfer requests for the two write data with respect to the two addresses transmitted from the second DMA apparatus at the same timing.

10. The data interleaving apparatus of any one of claims 1, 2, 4, 5, 6, 7, 8 and 9, wherein the memory device is a DRAM or an SRAM.
